(19) United States
(12) Patent Application Publication
(10) Pub. No.: US 2015/0103617 A1
(43) Pub. Date: Apr. 16, 2015

(54) DRIVEN FLUID MIXER AND RELATED METHODS

(71) Applicants: PALL LIFE SCIENCES BELGIUM BVBA, HOEGAARDEN (BE); PALL TECHNOLOGY UK LIMITED, PORTSMOUTH (GB)

(72) Inventors: Patrick Dujardin, Outgaarden (BE); Vishwas Pethe, Shakopee, MN (US); David M. Shofi, Ridgefield, CT (US)

(21) Appl. No.: 14/403,786

(22) PCT Filed: Jul. 3, 2013
(86) PCT No.: PCT/US2013/049210

§ 371 Date: Nov. 25, 2014

Related U.S. Application Data
(60) Provisional application No. 61/667,766, filed on Jul. 3, 2012.

(51) Int. Cl. B01F 15/00; B01F 3/04; B01F 5/12

(52) U.S. Cl. CPC B01F 15/00525; B01F 5/12; B01F 3/04113; B01F 15/0085; B01F 2215/0073
USPC 366/102; 261/78.2; 366/164.2

(57) ABSTRACT

A manner of providing an improved fluid processing arrangement, and bioprocessing in particular, is adapted to agitate the fluid, and also simultaneously provide for the distribution of gas throughout the fluid in order to maintain desirable processing conditions (such as an increased level of dissolved oxygen, in the case of biological applications). In some embodiments, the mixing would be completed without necessitating the use of an external drive motor or the like, such as by using a fluid-driven mixer. Overall, use of the improved arrangement leads to a simplification of the fluid processing operation with improved results and a concomitant reduction in the expense associated with such use.

### TECHNICAL FIELD

This disclosure relates generally to the fluid handling arts and, more particularly, to a driven fluid mixer and related methods.

### BACKGROUND OF THE INVENTION

It is often desirable in fluid handling applications to provide a measure of agitation for the fluid, typically using some form of externally driven impeller positioned in a fluid container or vessel. Past approaches have involved the use of direct, shaft-driven impellers, and well as indirect, magnetically coupled impellers, both for positioning in the interior of the fluid container.

More recently, a proposal has been made for a stirrer for disposable use that may be driven using air, as detailed in U.S. Patent Application Publication No. 2012/0040449, the disclosure of which is incorporated herein by reference. This approach attempts to address the above-mentioned requirement for an external motive device, yet limitations remain. For example, a separate conduit is required for returning the air from the device being driven to the environment outside of the container. Inputting gas to the fluid being processed may also be desirable, and especially in a manner that ensures a substantially even distribution of the gas throughout the fluid, but the proposal in the prior approach is for a tiny fixed aerator along only a portion of one gas delivery line.

Accordingly, a need is identified for a manner of providing an improved fluid processing arrangement, and bioprocessing in particular. The processing arrangement would be adapted to agitate the fluid, and may provide for the distribution of gas throughout the fluid to maintain desirable processing conditions (e.g., an increased level of dissolved oxygen, in the case of biological applications). In some embodiments, the mixing would be completed without necessitating the use of an external electric motor or the like. Overall, the improved arrangement would thus lead to a simplification of the fluid processing operation with improved results and a concomitant reduction in the expense associated with such use.

### SUMMARY

One aspect of this disclosure relates to an apparatus for use in processing a fluid in a vessel and for supplying a gas to the fluid. In one embodiment, the apparatus comprises a mixer adapted for supplying the gas to the fluid in the vessel, and a drive for delivering the gas to the mixer to cause the agitator to rotate.

The mixer may include an agitator capable of rotating to agitate the fluid, as well as a housing for at least partially housing the agitator. In one embodiment, the agitator comprises an impeller positioned within the housing for being driven by the gas. The agitator may also be external to the housing, and coupled to an impeller positioned within the housing. A magnetic coupling may couple the agitator to the impeller.

The mixer or, in some embodiments, the agitator, may include a passage for delivering gas to the fluid. The passage may extend within an extension of the agitator. The mixer or agitator may include a plurality of passages for delivering gas from the housing to the fluid.

The mixer may include at least one first opening serving as a fluid inlet and at least one second opening serving as a fluid outlet. At least one extension may be associated with the at least one second opening, said extension comprising a passage for delivering the gas to the fluid. The extension may comprise a blade associated with the mixer (which blade may connects to the agitator, which agitator is positioned external to a housing forming part of the mixer). The apparatus may further include a sparger connected to the mixer. The drive may also include a conduit for delivering the gas to the mixer.

In one aspect of the disclosure, an arrangement for processing a fluid using a mixer includes a blade having a passage for delivering a gas to the fluid. The arrangement may further include a drive for causing the mixer to rotate.

Another aspect of the disclosure pertains to an apparatus for agitating and supplying a fluid to an interior of a vessel. The apparatus comprises a mixer adapted for being rotated within the vessel, said mixer including an interior compartment and an agitator positioned in the interior compartment, and a drive for delivering the fluid to the interior compartment of the mixer. The mixer may be further adapted for releasing the fluid from the interior compartment of the mixer to the vessel interior. In one arrangement according to the foregoing, the drive is adapted to deliver the fluid in a manner that causes the agitator to rotate.

Yet another aspect of the disclosure relates to an apparatus for use in processing a fluid and supplying a gas to the fluid via a conduit. The apparatus may comprise a vessel for receiving the fluid, and a mixer for mixing the fluid in the vessel. The mixer includes an agitator capable of rotating relative to the vessel to agitate fluid, an inlet for delivering the gas from the conduit for driving the agitator, and an outlet for delivering gas to the fluid.

In one embodiment, the mixer comprises a housing including the outlet. The housing may include a wall having a plurality of outlets formed therein. The outlet may also be formed in the agitator, or may be connected to a passage in the agitator. The mixer may be located in the interior compartment of the vessel, and may be connected to the vessel.

Still a further aspect of the disclosure is an apparatus for use in fluid processing and for supplying at least one gas to the fluid during the processing via a conduit. The apparatus comprises a flexible vessel for receiving the fluid, and a mixer including an agitator adapted for being rotated relative to the vessel by way of the gas from the conduit. The mixer is further adapted for delivering the at least one gas to the fluid. In one embodiment, the flexible vessel comprises a bag including an opening for receiving the mixer such that the agitator is positioned in an interior compartment of the bag.

A further aspect of the disclosure relates to a gas driven mixer including a sparger for creating bubbles in a fluid being mixed. Furthermore, according to the disclosure, an apparatus may comprise a fluid container having an interior compartment in which the gas driven mixer including the sparger is located.

Yet another aspect of the disclosure relates to a fluid mixer adapted for providing gas to the fluid during the mixing, comprising: a first sparger for supplying gas to the fluid in a first direction and a second sparger for supplying gas to the fluid in a second direction. The mixer may further include a first source of a first gas connected to the first sparger and a second source of a second gas connected to the second sparger.

The disclosure may also provide a disposable bioreactor including a flexible pouch having an interior compartment for receiving a fluid, wherein it also includes a single-use stirring system placed entirely within said pouch; said stirring system comprising a drive adapted for delivering a gas to the interior of the flexible pouch and at least one stirrer driven in rotation by said drive. The stirrer may comprise an agitator adapted for rotating relative to the vessel. The agitator may deliver gas from the drive to the fluid.

This disclosure also relates to a method for processing a fluid, comprising: driving a mixer in contact with the fluid using a gas; and delivering the gas from the mixer to the fluid. In one possible approach, the delivering step comprises delivering the gas from the mixer to the fluid at a location remote from the mixer.

Another aspect of the disclosure relates to an apparatus for mixing a fluid. The apparatus may comprise a vessel for receiving the fluid, a mixer for agitating the fluid in the vessel, and at least two conduits, each conduit connected to the vessel at one end and to the mixer at the other end and adapted for supplying a fluid to the mixer.

The conduits may each be adapted to supply a different fluid to the mixer, such as a different gas or a gas and liquid. The mixer may include an inlet associated with each of the conduits, as well as an outlet for releasing the fluid to the vessel. Each conduit may connect to the vessel at one end of a double-ended connector adapted for connecting to an external fluid source.

Each conduit may connect to the vessel at substantially the same height. Alternatively, each conduit may connect to the vessel at a different height. Consequently, the mixer may comprise an impeller having an axis of rotation aligned with a vertical axis or not aligned therewith (such as by forming an acute angle).

This disclosure also pertains to an apparatus for mixing a fluid, comprising: a vessel including at least one sidewall forming an interior compartment for receiving the fluid; a mixer for agitating the fluid in the vessel; and a plurality of connectors for connecting the mixer to at least one sidewall of the vessel such that an axis of rotation of the mixer is not aligned with a vertical axis. The mixer may be fluid-driven, and at least one of the connectors may comprise a conduit for supplying a fluid for driving the mixer. The mixer may further include an outlet for releasing the fluid to the vessel. Each connector connects to the vessel at a substantially different height.

An apparatus comprising a flexible mixing bag, and a liquid substance circulation device associated with said flexible mixing bag, said liquid substance circulation device in turn comprising: an upper wall; a side wall, said upper wall and said side wall cooperatively defining a compartment; and a rotary magnetic element located in said compartment; wherein: at least one inlet is formed in said liquid substance circulation device for delivering a gas to the compartment. The outlet release gas from said device in the form of bubbles, and the apparatus may further include a source of gas for supplying gas to the inlet.

A further aspect of the disclosure relates to a method of supplying gas to a fluid in an interior of a mixing vessel, comprising shearing the gas bubbles in a compartment prior to introducing the gas from the compartment to the fluid in the interior of the mixing vessel external to the compartment. The method may further include the step of delivering the gas to a fluid in the compartment prior to the shearing step.

Still another aspect of the disclosure pertains to an apparatus for use in processing a fluid in a vessel and for supplying a gas to the fluid from a source external to the vessel. The apparatus comprises a mixer including an agitator capable of rotating relative to the vessel to agitate the fluid, said mixer including a housing having an inlet for receiving the gas, and a drive for causing the agitator to rotate. The agitator may comprise a magnetic impeller and the drive is adapted to form a non-contact coupling with the magnetic impeller. The housing may comprise a plurality of inlets for receiving the gas, as well as one or more outlets for forming gas bubbles.

A related aspect of the disclosure pertains to a method of forming a mixing vessel, comprising the step of providing a mixer for associating with the vessel, said mixer including a compartment adapted for receiving a gas from a source external to the mixing vessel; and providing a drive external to the vessel for forming a non-contact coupling for driving the mixer.

A method of mixing a fluid in a vessel also forming an aspect of this disclosure comprises supplying a gas to a mixer; and driving the mixer by way of a non-contact coupling formed with an external motive device. The method may further include the step of supplying a plurality of different gases to the mixer, as well as the step of supplying the gas to the mixer through a plurality of inlets. The method may further include the step of supplying a liquid to the mixer.

### BRIEF DESCRIPTION OF THE DRAWING FIGURES

FIG. 1 is a partially schematic perspective view of one embodiment of a mixer;

FIG. 2 is a partially cross-sectional top plan view of another embodiment of a mixer;

FIGS. 2a, 2b, and 2c are differing schematic views of alternate embodiments of the mixer;

FIGS. 3 and 4 are partially cross-sectional and perspective views of an embodiment of the mixer;

FIG. 5 is a schematic view of a container including a mixer according to the disclosure;

FIG. 6 is a partially cutaway, cross-sectional side view of the mixer of FIG. 6;

FIG. 7 is a perspective view of another embodiment of a mixer;

FIG. 8 is a partially cross-sectional, schematic view of a container including a mixer;

FIGS. 9 and 10 are schematic views of alternative arrangements of mixers in containers;

FIG. 11 is a partially schematic perspective view of another embodiment of a mixer; and

FIG. 12 is a schematic view illustrating a possible mode of operation of the mixer of FIG. 11.

### DETAILED DESCRIPTION

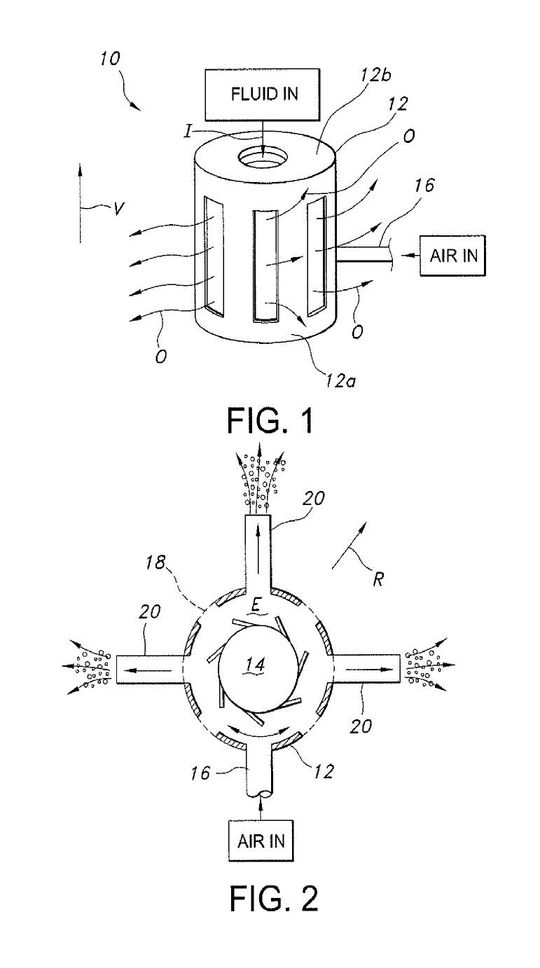

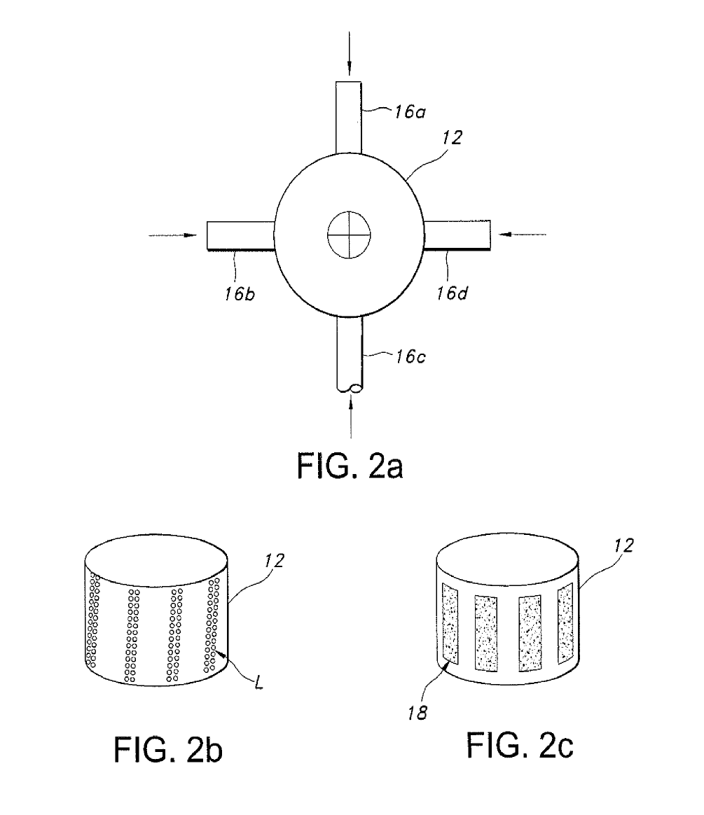

Reference is now made to FIGS. 1 and 2, which illustrate implementations of a fluid processing apparatus according to the disclosure. In the FIG. 1 embodiment, the apparatus for processing fluid is in the form of a mixer 10 adapted for being associated with a vessel or container (not shown) capable of at least temporarily containing the fluid. The association may be, for example, by positioning the mixer 10 in the interior compartment, surrounded by the fluid when present. The vessel or container may be, for example, a disposable or single use bioreactor, fermenter, or the like, and may be in the form of an at least partially flexible container, which may be referred to as a bag or pouch, but as noted below can take different forms.

The mixer 10 may comprise a housing 12, for at least partially containing an agitator for agitating the fluid. The agitator may take the form of an impeller 14 adapted for rotating within the housing 12, such as by being mounted to a bearing (not shown) that is fixed in place (which may include a slide bearing, a roller bearing, a thrust bearing, or like structure) or one that is not fixed in place (such as a fluid bearing) that facilitates low friction, controlled rotation. The impeller 14 may also be associated with an axle (not shown) journaled in the housing 12 and defining the axis of rotation. The agitator, such as impeller 14, may include blades, vanes, or like elements, as illustrated, but may comprise any structure capable of agitating the fluid.

A drive may also be provided for driving the mixer 10 and causing it to agitate the fluid in the associated vessel or container. In one embodiment, the drive may include a conduit 16 for introducing a fluid in the form of a gas, such as air, used to actuate the impeller 14, such as by causing it to bodily rotate or spin relative to the housing 12 and any vessel or container with which the mixer 10 is associated (such as by being positioned at least partly within an interior compartment thereof). The gas may be delivered to the interior of the housing 12 under pressure from an external supply, such as a compressor, fan, blower, pressurized container, or the like.

The housing 12 also includes one or more openings that serve to facilitate the mixing of the fluid. In the particular embodiment of FIG. 1, the housing 12 includes a sidewall 12a with one or more circumferentially spaced openings that are elongated in a vertical direction V, as shown. A further wall of the housing 12, such as the upper or top wall 12b, may also be provided with one or more openings. The housing 12 may also include a planar bottom wall (not shown), which may be the wall associated with the mixer 10.

In use, a gas, such as air, or other fluid delivered to inlet 16 may propel the impeller 14 about an axis of rotation and relative to the housing 12, which may remain stationary. In the case of gas, it mixes with any liquid present in the interior compartment E when the mixer 10 is at least partially submerged. In one particular embodiment, as illustrated, fluid may be drawn through the opening(s) in the upper wall 12b, which thus creates an inlet I, mix with the gas or air in the interior of the housing 12 to drive the impeller 14, and then a composite fluid (e.g., air-liquid mixture) ejects from the opening(s) in the sidewall 12a, which thus serve as outlet(s) O.

As should be appreciated, this may result not only in fluid agitation, but also mixing of the injected gas (e.g., air) with the fluid, and may thus improve the concentration of dissolved gas (e.g., oxygen). The temporary residence of a gas in the interior compartment E of the housing 12 combined with the rotation of the impeller 14 may also help to create shear in the gas bubbles. This may create finer bubbles as compared to the case in which the gas is simply introduced into the fluid in the vessel without encountering mixer 10.

The openings in the sidewall 12a may be unobstructed, as shown in FIG. 1. Alternatively, as indicated in the cross-sectional view of FIG. 2, these sidewall openings may be adapted for delivering the gas-fluid mixture from the interior compartment E in a controlled manner. For instance, one or more of the openings may be provided with a porous substrate 18 that regulates the rate of delivery of the mixture from the housing 12 (and concomitantly controls the resident time of the gas in the interior compartment E once delivered thereto from conduit 16). The substrate 18 may comprise a membrane having micro- or macroscopic openings (e.g., holes, pores, slits, etc.) in order to provide the desired level of regulation. A substrate (not shown) may also be provided in association with the opening in the upper wall 12b in order to regulate fluid flow into the interior compartment E of the housing 12, and could possibly include the option of blocking fluid flow such that only gas exits the housing as a result in the supply through conduit 16. The openings may also be provided with removable covers, such as doors (not shown), to allow for selective use (e.g., one or more may be opened, while others are closed), depending on the particular application.

Additionally, or alternatively, the housing 12 may include optional extensions 20 for communicating with one or more of the openings in the sidewall 12a. The extensions 20 may be tubular, and project from periphery of the housing 12, such as in the radial direction R. Consequently, the extensions 20 may serve to eject the gas-fluid mixture at a remote location from the housing. This may improve the gas distribution thoughout the fluid, especially in the case of multiple extensions 20 that project in different directions (radial, vertical, or any combination thereof). The extensions 20 may also comprise or be associated with spargers.

The mixer 10 may also be used in various alternative embodiments. For example, multiple inputs may be provided for introducing the same or different fluids (liquid or gas) to the housing 12. Thus, in the embodiment shown, four conduits 16a, 16b, 16c, and 16d are illustrated by way of example only, each being connected to the sidewall 12a of the housing 12 (which may still include openings as discussed previously).

This arrangement may allow for different gases (e.g., oxygen, nitrogen, carbon dioxide, etc.), liquids (nutrients, fresh media, etc.), or combinations of both to be simultaneously introduced into the compartment E of the mixer 10. Likewise, the arrangement could allow for multiple sources of the same fluid to be used in connection with the mixer 10, with the delivery being either sequential or simultaneous.

FIG. 2b shows that the openings in the sidewall 12a may be arranged to create bubbles from any gas introduced into the interior compartment of the housing 12, such as via the inlet 16 or inlets. For example, groups of relatively small (e.g., 1-2 mm) openings may be provided in and along the sidewall 12a, such as in spaced columns L, but any desired pattern may be used. Likewise, as mentioned above and shown in FIG. 2c, the openings may be covered with a substrate 18 that is porous (such as, but not limited to, one having openings of about 50 μ or less) to form bubbles from any gas introduced into the housing 12 via inlet(s) 16. Combinations of the two approaches could also be used. These approaches to supplying gas to the fluid surrounding the mixer 10 may also be applied to extensions 20 from the housing 12.

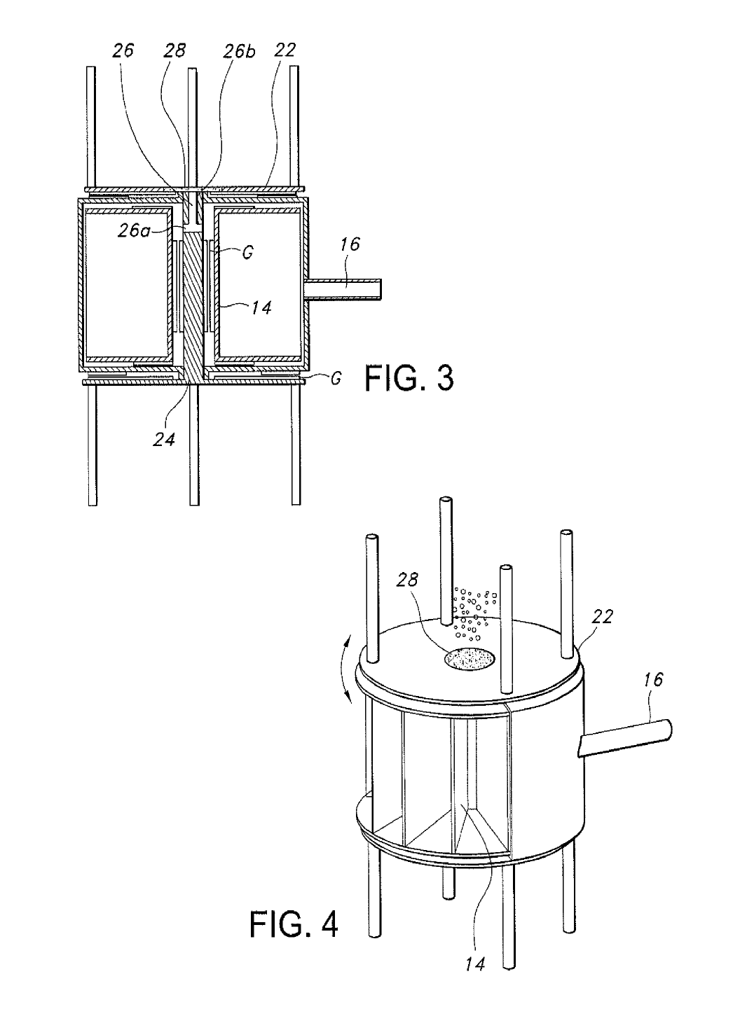

Reference is now made to FIGS. 3 and 4, which illustrate a further embodiment in which an impeller 14 may be driven by a fluid, such as for example a gas supplied by a conduit 16 from an external supply. The impeller 14 within the housing 12 is adapted for forming a non-contact coupling with an external agitator 22 for positioning within a container or vessel (not shown) to create the desired fluid agitation. The non-contact coupling may be achieved using magnets G.

In the illustrated embodiment of FIGS. 3 and 4, a portion of the agitator 22, such as an axle 24 extending into the housing 10, is adapted for delivering the gas or air that drives the agitator (such as by engaging the impeller 14), to the fluid external to the housing 12. This may be achieved by providing the axle 24 with an internal passage 26. At one end 26a, this passage 26 may communicate with the interior compartment E, and at the other end 26b with the fluid external to the housing 12. This other end 26b may be adapted to permit the delivery of the gas to the fluid, as well as to prevent the fluid from entering the passage 26 and thus the housing 12. This may be achieved using a suitable control device, such as a one-way valve in the form of a porous membrane 28 having pores of sufficient size to allow the gas to pass but not the fluid (and depending on the pore size may also serve to create bubbles in the fluid and thus serve as a sparger and perform a sparging function). However, the end 26b of the passage 26 may also simply be open to the fluid.

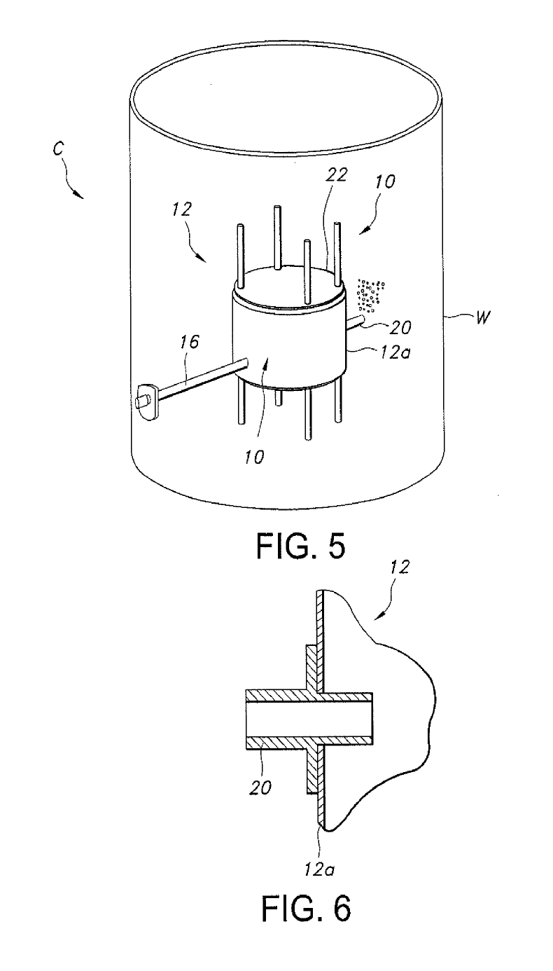

FIG. 5 shows another embodiment in which the gas from the housing 12 is released into a surrounding fluid through an opening in the mixer 10. As further indicated by FIG. 6, the opening may be formed in the housing sidewall 12a, and also may be associated with an extension 20 for delivering the gas to the fluid in a controlled manner (e.g., direction, flow rate, etc.) and at a location remote from the agitator 22. While only one opening is depicted, it may be appreciated that multiple openings may be provided, as shown in the embodiment of FIGS. 1 and 2. Also, as with that embodiment, the extension(s) 20 are optionally provided and may project in different directions (radially, vertically, tangentially, or combinations thereof). In any case, it can be appreciated that only a single conduit 16 may be used to deliver the fluid to the mixer 10, which allows for a simply arrangement to be created.

A container C is also shown in FIG. 5 for receiving the mixer 10. The container C may comprise a partially or completely rigid tank, or a partially or fully flexible vessel (bag, pouch, or the like). The mixer 10 may be indirectly connected to a wall W of the container C, such as by a tether formed using the conduit 16, to create a spaced or indirect connection. The mixer 10 may be arranged such that the wall 12a of the housing 12 is connected directly to the wall W of the container C, including possibly in suspension.

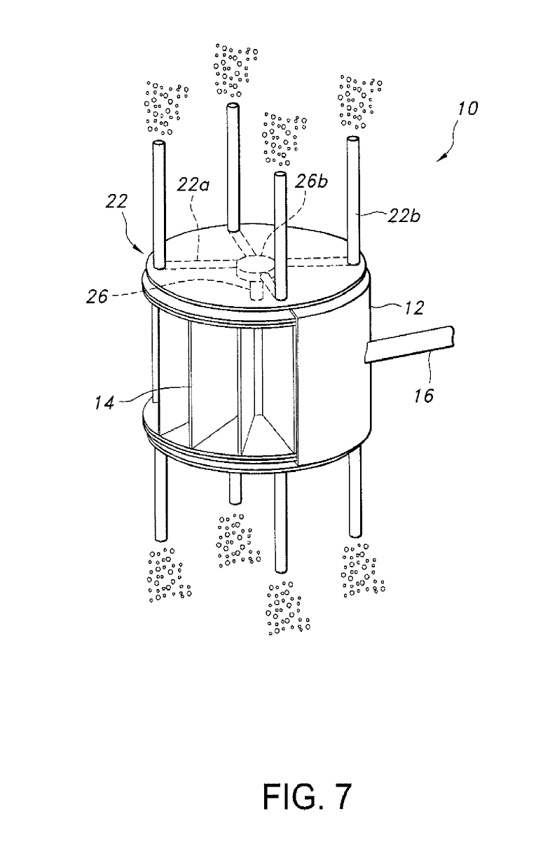

Turning now to FIG. 7, a further embodiment of a mixer 10 is shown. In this embodiment, a portion of the agitator 22 is adapted to receive the gas from the housing 12, which gas is introduced to cause the relative movement between the two structures. For example, the agitator 22 may be associated with an axle (not shown) having a passage 26 similar to that shown in FIG. 3. Rather than releasing the gas directly to the fluid at a single location, the passage 26 at one end 26b forms a distributor that distributes the fluid through one or more internal channels 22a in the agitator 22. The channels 22a may, in turn, communicate with openings in the agitator 22 for delivering the gas to the surrounding fluid. For example, the openings in the agitator 22 may be associated with extensions, such as blades 22b, which may be tubular or otherwise adapted to deliver the gas from the channels 22a to the surrounding fluid (which extensions may thus be considered to form spargers for creating gas bubbles in the fluid).

As should be appreciated, the rotation of the agitator 22 as the result of the gas delivery through conduit 16 to housing 12 combined with the delivery of the gas to the fluid advantageously performs the dual function of agitating the fluid while delivering gas to it (and especially when the passage 26 is arranged to supply the gas to multiple sides of the agitator 22 simultaneously, as shown). Thus, the gas delivery in this particular embodiment is provided in two different directions, which as shown may be opposite each other (yet both aligned with the axis of rotation of the mixer 10). Furthermore, as discussed elsewhere herein, it is possible to use multiple inlets or conduits 16 for supplying different fluids from different sources (not shown) if desired, supplying fluids at different rates, or alternating the supply.

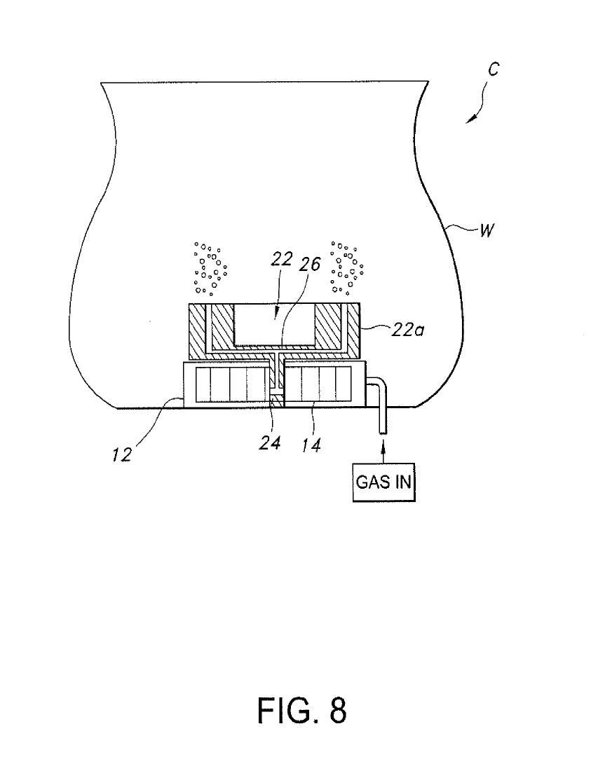

A further embodiment of a mixer 10 is shown in FIG. 8, which is illustrated as part of a container C having a flexible wall W and thus forming a bag or pouch. The mixer 10 comprises a housing 12 for receiving an impeller 14, which may be driven by a gas supplied through an external conduit 16. The impeller 14 is directly attached to an agitator 22 external to the housing 12 by an axle 24, and thus the two structures rotate together. Optionally, a passage 26 may be formed along the axle 24 to deliver the gas to the fluid, such as by extending through the passages in the agitator 22 and forming an outlet along extensions thereof, such as blades 22a. Alternatively or additionally, the housing 12 may be adapted for releasing the gas into the surrounding fluid, such as by using openings (not shown in FIG. 8, but see FIGS. 1 and 2).

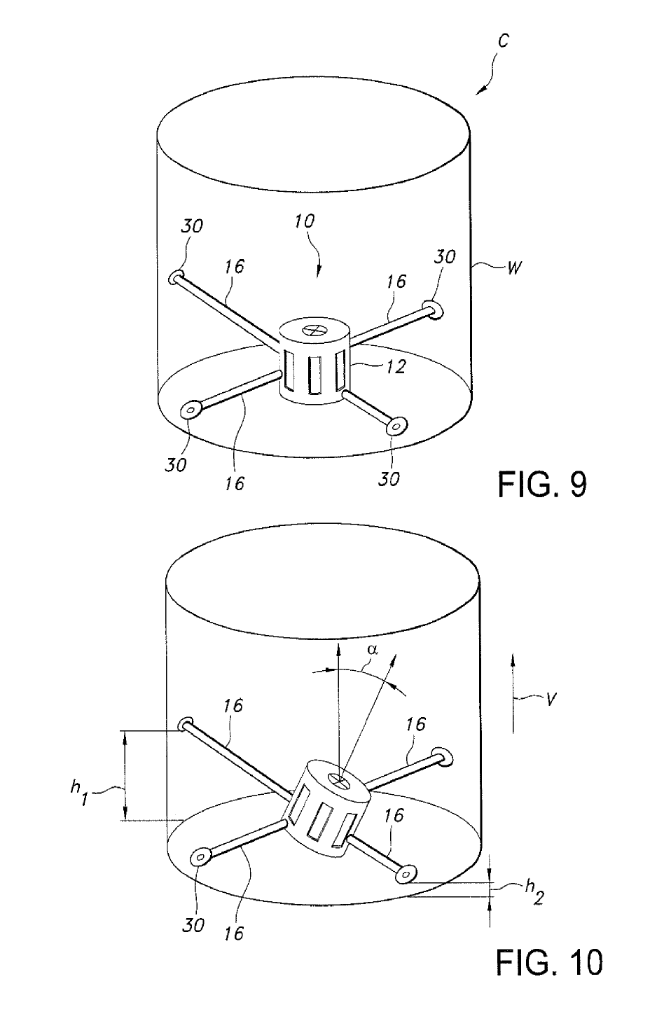

FIGS. 9 and 10 illustrate different approaches to mounting the mixer 10 relative to an external container C, which may comprise a rigid vessel or a flexible vessel, such as a bag or pouch. FIG. 9 shows that a plurality of external conduits 16, such as flexible tubes, may be connected between the housing 12 and the sidewall(s) W of the container C (which may be considered a single sidewall when the container is generally cylindrical, as shown, but could also be multiple sidewalls when the container has a polygonal configuration, such as cubic or rectangular). The tubes serving as conduits 16 may be connected to the wall W or walls (e.g, a first conduit may connect with a first wall and a second one with a second wall) in a manner that allows for the transmission of fluid, such as by using connectors 30 in the form of double-ended fittings (which may be similar in construction, for example, to the extension 20 shown in FIGS. 5 and FIG. 6). The connectors 30 may be specially adapted for coupling with a source of fluid (gas or liquid) external to the container C, such as by using a locking engagement (bayonet, screw fitting, or the like), which may be delivered under sterile conditions if desired.

As should be appreciated, the connectors 30 may be positioned along the container C at any height. Moreover, the connectors 30 may each be positioned at the same height, or one or more may be positioned at different heights (see, e.g., h₁ and h₂ in FIG. 10) to alter the position of the mixer 10 (note, for example, acute angle a between the rotational axis of impeller 14, which is not aligned with an axis extending in the vertical direction V). The connectors 30 may be one or more tubes as discussed above, or may include one or more non-tubular tethers for tethering the mixer to the container C.

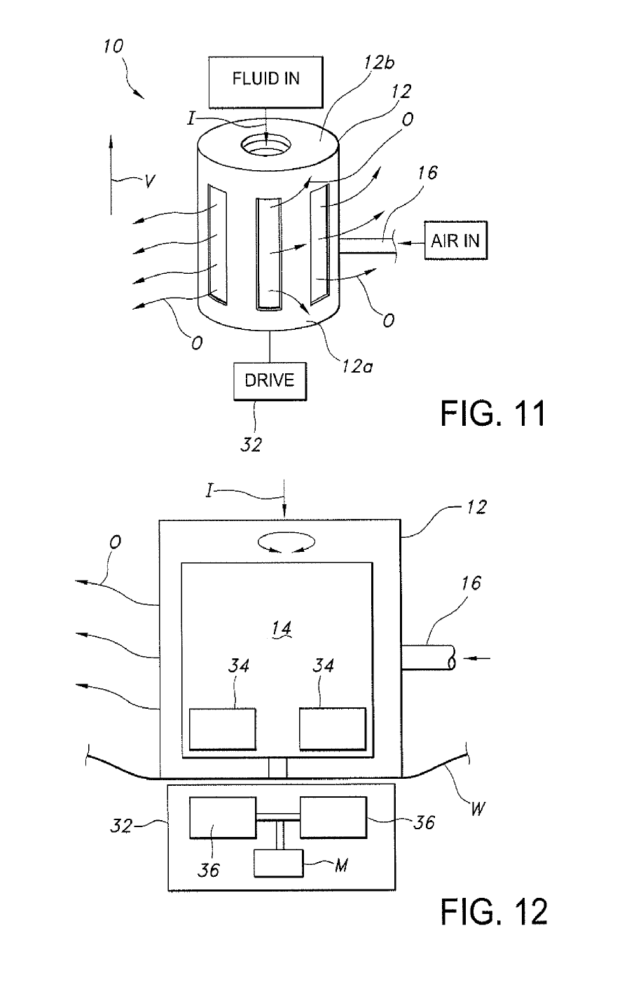

Actuation of the mixer 10 may be achieved without using the fluid to do so. Thus, as shown in FIGS. 11 and 12, an external drive 32 may be used for driving the impeller 14 to rotate within housing 12, while a fluid, such as air, is introduced via the conduit 16 associated therewith. The drive 32 may form a non-contact coupling with the impeller 14 through an external wall W associated with the mixer 10 (and possibly fanning part of a larger vessel or container, not shown). For example, as shown in FIG. 12, driven magnets 34 of the impeller 14 may associated with drive magnets 36 driven by the drive 32 (which arrangement could also be applied to the FIG. 8 embodiment). The housing 12 may include the fluid inlet I and may provide the output 0 in the manner described herein. Further details of possible non-contact drive arrangements may be found in U.S. Pat. No. 7,481,572 and International Application PCT/EP07/53998, both of which are incorporated herein by reference. As another example, one or more of the connectors 30 in the FIGS. 9 and 10 embodiments may also be used to supply electricity for powering the mixer 10.

The foregoing descriptions of several embodiments made according to the disclosure of certain inventive principles herein are presented for purposes of illustration and description. The embodiments described are not intended to be exhaustive or to limit the invention to the precise form disclosed and, in fact, any combination of the components of the disclosed embodiments is contemplated. The term “flexible” as used herein in the context of the vessel refers to a structure of the vessel that, in the absence of auxiliary support, may conform to the shape of the fluid contained in the vessel, as contrasted with a “rigid” structure, which retains a pre-determined shape when the fluid is in the vessel. A liquid, such as water, may also be used to drive the mixer 10 in certain embodiments (e.g., FIGS. 1 and 2), and which arrangement may be used to pump the liquid. A vent may also be provided for venting the interior compartment of any vessel including the mixer 10, and may be associated with a sterile filter in order to maintain an aseptic condition in the vessel (which may be otherwise hermetically sealed). Modifications or variations are possible in light of the above teachings. For example, any shape or style of agitator may be used, including one with vanes or fins similar to the blades shown in the figures. The embodiments described were chosen to provide the best illustration of the principles of the invention and its practical application to thereby enable one of ordinary skill in the art to utilize the invention in various embodiments and with various modifications as are suited to the particular use contemplated. All such modifications and variations are within the scope of the invention when interpreted in accordance with the breadth to which it is fairly, legally, and equitably entitled.

1. An apparatus for use in processing a fluid in a vessel and for supplying a gas to the fluid, comprising:
a mixer adapted for supplying the gas to the fluid in the vessel, the mixer including an agitator capable of rotating to agitate the fluid; and
a drive for delivering the gas to the mixer to cause the agitator to rotate.

2. The apparatus of claim 1, wherein the mixer comprises a housing for at least partially housing the agitator.

3. The apparatus of claim 2, wherein the agitator comprises an impeller positioned within the housing for being rotatably driven by the gas.

4. The apparatus of claim 3, wherein the agitator is coupled to an impeller positioned within the housing.

5. The apparatus of claim 3, wherein a magnetic coupling couples the agitator to the impeller.

6. The apparatus of any of the foregoing claims claim 1, wherein the agitator includes a passage for delivering gas to the fluid.

7. The apparatus of claim 6, wherein the passage extends within an extension of the agitator.

8. The apparatus of claim 6, wherein the agitator includes a plurality of passages for delivering gas from the housing to the fluid.

9. The apparatus of claim 1, wherein the mixer includes at least one first opening serving as a fluid inlet and at least one second opening serving as a fluid outlet.

10. The apparatus of claim 9, further including at least one extension associated with the at least one second opening, said extension comprising a passage for delivering the gas to the fluid.

11. The apparatus of claim 10, wherein the extension comprises a blade associated with the mixer.

12. The apparatus of claim 11 , wherein the blade connects to the agitator, which agitator is positioned external to a housing forming part of the mixer.

13. The apparatus of any of the foregoing claims claim 1, further including a sparger connected to the mixer.

14. The apparatus of any of the foregoing claims claim 1, wherein the drive includes a conduit for delivering the gas to the mixer.

15. In an arrangement for processing a fluid using a mixer including a blade, the improvement comprising a passage in the blade for delivering a gas to the fluid.

16.-28. (canceled)

29. A fluid mixer adapted for providing gas to the fluid during the mixing, comprising: a first sparger for supplying gas to the fluid in a first direction and a second sparger for supplying gas to the fluid in a second direction.

30. The mixer of claim 29, further including a first source of a first gas connected to the first sparger and a second source of a second gas connected to the second sparger.

31.-35. (canceled)

36. An apparatus for mixing a fluid, comprising:
a vessel for receiving the fluid;
a mixer for agitating the fluid in the vessel; and
at least two conduits, each conduit connected to the vessel at one end and to the mixer at the other end and adapted for supplying fluid to the mixer.

37.-65. (canceled)
